(19) United States
(12) Patent Application Publication
(10) Pub. No.: US 2022/0375013 A1
(43) Pub. Date: Nov. 24, 2022

(54) Method And Apparatus For Cannabis and Cannabinoid Rights Certification, Verification, And Tracking System

(71) Applicant: Stanislav Chijik, New York, NY (US)

(72) Inventor: Stanislav Chijik, New York, NY (US)

(21) Appl. No.: 17/748,829

(22) Filed: May 19, 2022

Related U.S. Application Data
(60) Provisional application No. 63/191,923, filed on May 21, 2021.

(51) Int. Cl. G06Q 50/18

(52) U.S. Cl. CPC G06Q 50/184

(57) ABSTRACT

A platform containing information related to cannabis strains and products and production (minting) of NFTs related to the cannabis strains and products. The NFTs are utilized to show ownership and chain of title of the cannabis and provide a basis for minting new NFTs representing at least one or more portions of the ownership rights. The NFTs are configured to provide access to information and authentication of the cannabis strains and products. The NFTs may be sold, exchanged, or provide a basis for licensing various rights associated with the strains and products.

### CROSS REFERENCE TO RELATED APPLICATIONS

This application claims the benefit of priority to U.S. Provisional Patent Application Ser. No. 63/191,923, entitled “Method And Apparatus For Cannabis and Cannabinoid Rights Certification, Verification, And Tracking System,” Attorney Ref. STAS-0100, filed 21 May 2021, which is hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Field

The present application relates tracking and exchange processes.

### Description of Related Art

Growers to retail supply chains for cannabis products are known.

### SUMMARY

The present inventor has realized the need to provide enhanced tracking, verification, and other features to supply chains, cannabis genetics and related IP, and various cannabis/cannabinoid products (or services). The present application describes many embodiments and no single feature or component of one embodiment is exclusive thereto or required in any other embodiment even if described or implied as important to a particular embodiment.

In one embodiment, the present application provides a cannabis exchange, comprising at least one strain of cannabis maintained in an NFT of a block-chain, and an interface for searching and reviewing cannabis strains in the collection. Such strain may be, for example, genetics information about the strain. The NFT may include, for example, at least one of Strain Name, Producer, Yield, Potency, THC, CBD, Terpenes, and Cultivation Methodology with respect to each strain. The interface may comprise a grower specific interface with searching functions of interest to growers (e.g., b2b searches), and a consumer specific interface with searching functions related to consumer interest. The interface may comprise an interface to one or more websites, such as for retail stores, chains, or wholesalers.

In another embodiment, the present application provides a method comprising the steps of, populating an NFT of block-chain with specifics of a cannabis strain, and providing portions of the NFT to third parties for evaluation of the cannabis strain. The specifics may be, for example, any one or combination of IP information, licensing information, earliest evidence of strain cultivation, an offer to license a strain, a license to clone the strain, genetics information or analysis, documentation from a supplier, chain of custody, a certification, documentation as to growing conditions of the strain, chemical content, taste, age, genetics, growing conditions, age, or other specifics of the strain, DNA data of the strain. The method may further comprise a step of providing a service including geographic transmission of the DNA data. The method may further comprise a step of linking the NFT to verification by an independent standards, testing, or review organization. The NFT may comprise any of a tradable quantity of cannabis, a tradable bundle of rights to a strain. The step of providing may comprise populating a retail web page with selected specifics and/or verification of the specifics of the strain. The specifics may include genetic information and the method may further comprise providing a service including a genetics search function of the block-chain.

The present application also provides a cannabis blockchain comprising a link to verification information about the quality of one or more products or grows (Past, present, or future) which may include a digital certification registered to one or more purchasers of the grow or any rights associated therewith.

The various embodiments may include or be realized as, for example, an analysis, verification, and/or marketing tool implemented in block-chain with Non-Fungible Tokens (NFTs), and implemented with block-chain tools or in other formats. Portions of the embodiments, whether a device, method, or other form, may be conveniently implemented in programming on a general purpose computer, or networked computers, and the results may be displayed on an output device connected to any of the general purpose, networked computers, or transmitted to a remote device for output or display. In addition, any components of any embodiment represented in one or more computer program or module(s), data sequence(s), and/or control signal(s) may be embodied as an electronic signal broadcast (or transmitted) at any frequency in any medium including, but not limited to, wireless broadcasts, and transmissions over copper wire(s), fiber optic cable(s), and co-ax cable(s), etc.

### DESCRIPTION OF THE DRAWINGS

A more complete appreciation of the various embodiments and many of the attendant advantages thereof will be readily obtained as the same becomes better understood by reference to the following detailed description when considered in connection with the accompanying drawings, wherein:

FIG. 1 is an illustration of a blockchain 100 for cannabis genetics;

FIG. 2 is an illustration of applications and products for the cannabis industry; and

FIG. 3 is an illustration of exemplary value added 300 available to various industry members provided by the present application;

FIG. 4 is a drawing of a hierarchy of NFTs minted on a Strainable Platform according to an embodiment;

FIG. 5 is a screen shot of an application/submission interface that may be utilized by the platform for registering an owner according to an embodiment;

FIG. 6 is a screen shot of an images tab utilized to upload and display images of products according to an embodiment;

FIG. 7 is a screen shot of a laboratory input including scientific inputs regarding a strain according to an embodiment;

FIG. 8 is a screen shot of a mint screen where a user inputs information about NFTs to be created for a strain, crop, or supply according to an embodiment;

FIG. 9 is a screen shot of a search page used by a user to, for example, review various available strains or products, and a results list according to an embodiment;

FIG. 10 is an architectural drawing of the platform and distributed processing, archives, and other tasks according to an embodiment; and

FIG. 11 is an architecture and operational flows diagram according to an embodiment.

### DESCRIPTION

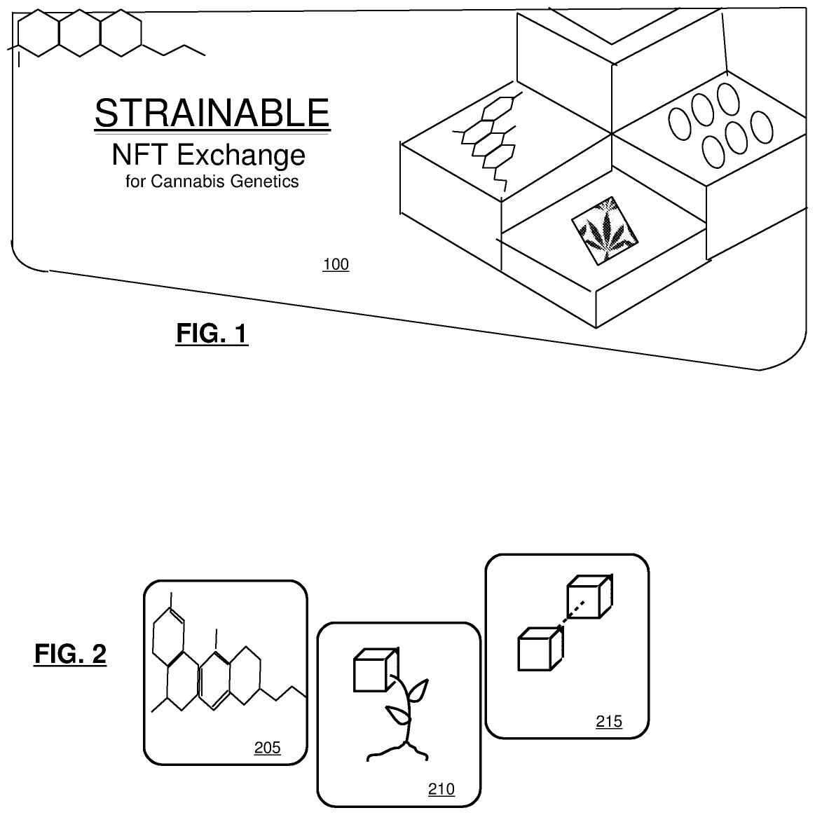

Referring now to the drawings, wherein like reference numerals designate identical or corresponding parts, and more particularly to FIG. 1 thereof, there is illustrated a blockchain 100 for cannabis genetics, herein described as and in reference to the Strainable Platform, which may be described as an exchange or marketplace for cannabis growers (or others) to create NFTs of their strains (or other assets) and mint them on blockchain. Made for, for example, growers and buyers of all sizes interested in selling their genetics (and may be extended to products, options, commodity, and other rights) and the rights to grow them (e.g., cloning and/or cultivation in various manners).

FIG. 2 is an illustration of applications and products for the cannabis industry. For example, genetics 205, cannabis products 205, and buy/sell/trade of cannabis related NFTs 210.

The exchange or platform may be provided to end users in many ways. For example, as presented herein as a non-limiting example (Strainable) and information distribution (and which may be based on or presented in any of a website, advertisement, social media post or the like). For example, in one embodiment, the platform provides a marketplace for cannabis growers to create NFTs (Non Fungible Tokens) of their strains and mint them on blockchain. The platform is, for example, provides facilities for growers and buyers of all sizes interested in selling their genetics and the rights to grow them. The same may be extended to sale of actual products. Provided are, for example, tools for the creation of NFTs for a strain, tools to license rights of a strain (e.g., a developer of a strain licensing to a grower or to a broker, for example. In another case, a sublicense between a licensed grower and another grower in the case where the licensed grower also obtained a license to sublicense). Also provided, for example, are tools to buy, sell, or trade clones. In one embodiment, tools for licensing a clone are included.

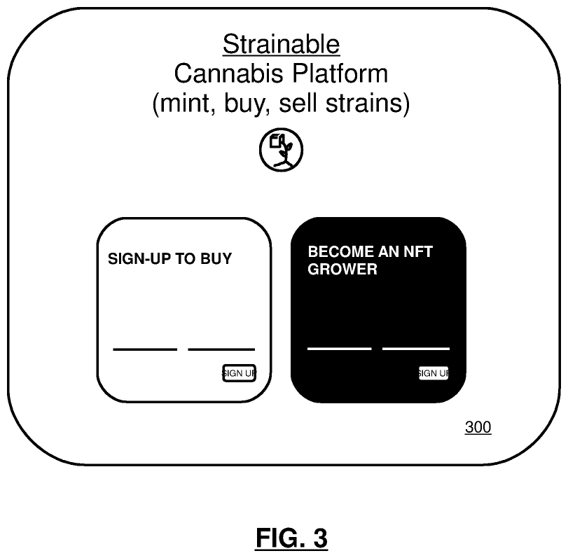

FIG. 3 is an illustration of exemplary value added available to various industry members provided by the present application, and particularly sign-in and sign-up 300 of exchange users because linking a cannabis strain to an NFT creates an enduring record of its genetic attributes for tracking and other purposes of the platform. Strainable as platform as described in this example makes it easy to buy, sell, and authenticate a cannabis strain, reducing or eliminating middlemen and/or expensive legal fees. The platform has revenue generation opportunities in essentially every aspect of its operation including advertising on the platform or direct marketing via email or snail mail, for example/Further, charges may be incurred for NFT generation, NFT sales (commission or subscription services, for example). Memberships and/or subscriptions, verifications. In one embodiment a subscription may provide a user (e.g., consumer, owner, etc.) with a package of a number of NFT/QR code scans and access to all data on the platform corresponding to that scanned. The subscription may be unlimited. Sale or licensing of Cannabis pharmacological and genetic data. All such sales or licensing may be on a rate schedule or commission or traded for further services or part of a deal encompassing other products, such as the provision of event hosting (which may or may-not be related to one or more of the cannabis products discussed herein). Ownership, sale, or licensing of DNS data, clone sales and delivery, etc.

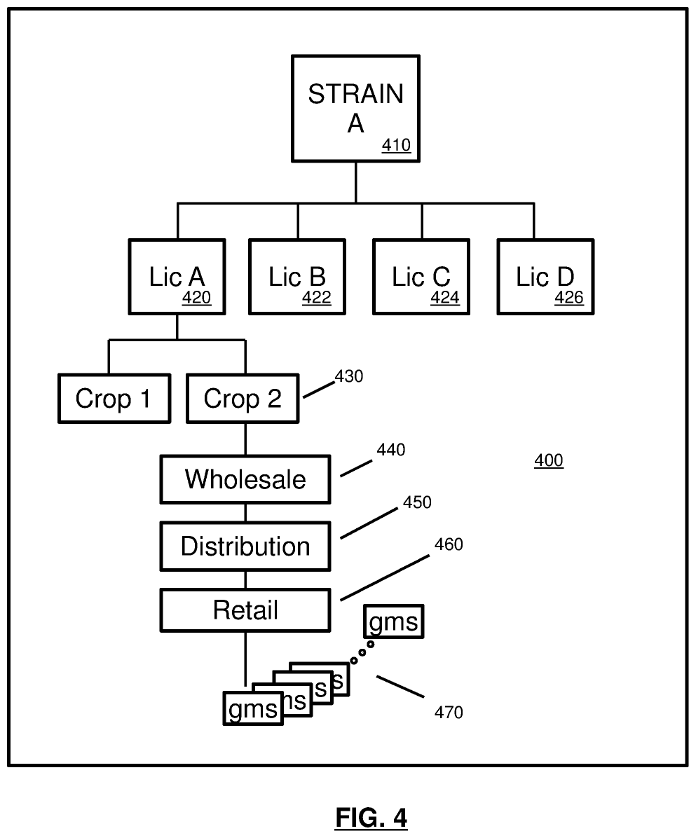

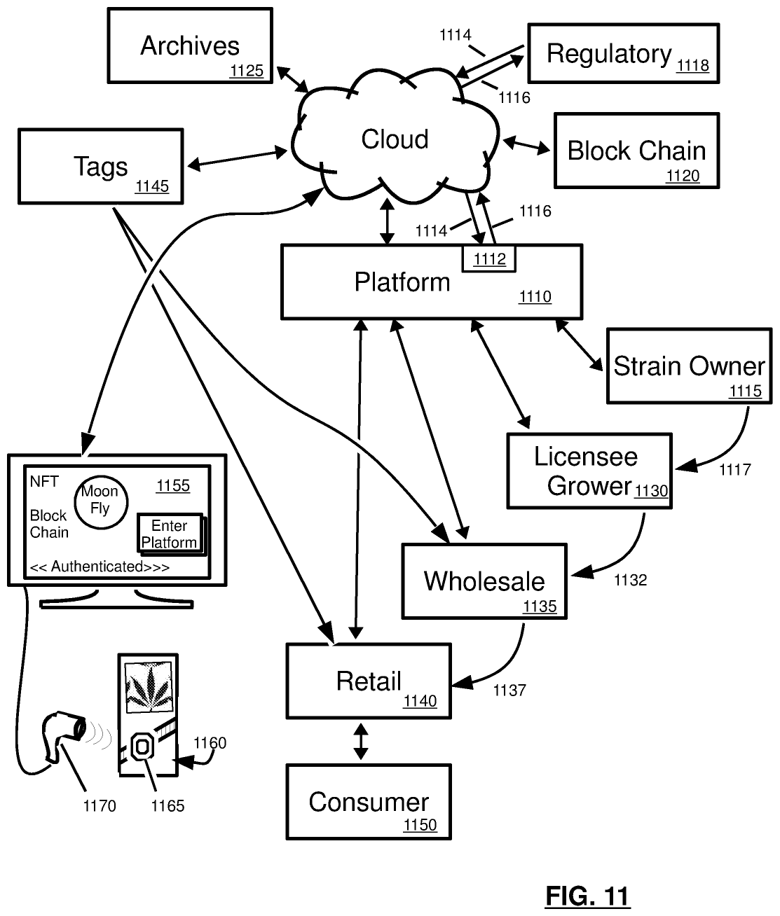

In FIG. 4, there is provided a hierarchy of NFT minting and there is shown a strain 410 that has already been logged and minted on, for example, the Strainable platform. The owner of this strain has either created or authorized the creation four separate licenses for the strain (420, 422, 424, and 426). Licensee A (420) has, under his license, grown two crops, crop 2 (430) has been sold to a Wholesaler 440. The wholesaler may, for example, have divided crop 430 into smaller portions to provide to distributor 450 or the distributor could have bought the entire crop and the distributor then packaged the entire crop in package sizes appropriate for a retail establishment 460. The retail establishment will take possession of one or more of those packages and then, as is typical in the industry, repackage them into smaller gram weight type packages 470 for sale to consumers. At each step of the way, each entity (licensee, wholesaler, distributor, retailer, or other entities in the chain of distribution), should they choose, have the option to go to the Strainable Platform and identify that they have acquired (if not already logged by the seller or selling transaction, which typical will occur automatically) which are known and authenticated quantities of product and that they are going to place in retail packages, mint separate NFTs for each package so that at the retail level each consumer who purchases a grams package 470 would receive their own NFT corresponding to their specific grams package. Likewise at any of the wholesale, distribution, or other levels appropriate NFTs may be minted. The NFTs provide a separately verifiable part of the whole crop that was produced originally and under an appropriate license. If requested, the Strainable Platform then makes contact with a tag producer who then ships the tags to a verified owner which may be provided inside (e.g., visible through a window) or outside the package. The tags provide the entities at whatever level wholesale through consumer with a physical visual indication of authentication of the product and also a key with which they can access the NFT and all corresponding data regarding the product as far as quality taste growing conditions genetics etc., however there may be some data that is excluded from view from the consumer such might be the case for example DNA listings etc. Nonetheless the information that can be available is voluminous including technical and chemical specifications for the strain, videos of planting harvesting, and processing (such videos may include a time lapse video that shows the entire growing season in, for example, 30 seconds. The videos may include a video of a technician opening a wholesale product and placing a portion of the product on scale and into the very package with which the NFT tag is attached. The NFT tag may be scanned at a kiosk (e.g., see FIG. 11) which links to the platform which then accesses the blockchain and verifies the product indicating the same on screen and providing a gateway to enter the platform to review even more detailed information. The kiosk may be, for example, a trusted kiosk registered to a sell of products associated with the platform and may communicated with the platform via an encrypted connection.

In one embodiment, access to the platform is limited to trusted, verified customers over secure links (and may also be further secured via scanning of an authentication code—e.g., tag identifying an NFT—associated with the kiosk or location of the NFT. For example, an authenticated log-in in combination with a scan of a tag from a smartphone of a known registered account, or a kiosk at a known retailer location). All of the above is exemplary in nature as many combination will be apparent to the skilled artisan upon review of the present application. In one embodiment, scans of tags or QR codes or any other type of query about an NFT are controlled by user preferences. For example, an owner of an NFT may register preferences with the platform on how to deal with scans of an NFT associated tag or QR code, such as the case where a scan comes into the platform from another registered user, which the owner may approve. In the case where an inquiry comes in from a non-registered user, the owner can set a preference to disapprove or not respond to the request. In another example, a retail outlet may set preferences to allow scans for all of their products if the scan is coming in from an authenticated kiosk, a registered user, and/or a smart phone providing location information showing the user is present in the store. The preferences may be set as a series of radio selection boxes describing each situation.

The marketplace may be implemented, for example, on a platform (e.g., the Strainable Platform) that manages the above tasks creating one or more NFT(s) documenting any transactions, providing authentication, and security. For example, linking a cannabis strain to an NFT creates an enduring record of its genetic attributes for tracking purposes. This also allows for efficient ease of buying, selling, and authenticating cannabis strains and products—and can be done automatically. In addition, the NFT(s) created may also be linked to NFT(s) created specifically for a crop and may be propagated (minted) with further downstream NFTs as a crop moves from sale/license of a strain/genetics to planting, harvesting, to one or more wholesalers, distribution and then retailers.

Looking from the retail side, purchase of a cannabis product by a consumer may include a physical tag, stamp, or seal of authenticity on the packaging (or a certificate or card included with a product) that links to an NFT that authenticates the product, such as the aforementioned tag in the discussion of FIG. 4. In one embodiment, information identifying the NFT authentication is on a trading card. The authentication may extend to any details about the product that the developer(s), grower(s), distributor(s), and or retailer(s) decide to include. This may be, for example, its name (e.g., Mendocino Red Bale, Blue Ti, etc.) and retail characteristics (color, texture, taste, etc.), its genetics, where it originated, where it was grown, under what conditions it was grown, when was it grown (“vintage”), what generation it is, how much of this product/generation was grown.

The platform, for example, provides tools for selling and propagating NFTs. For example, a grower buys the rights to Strain A also acquires an NFT documenting that right. Grower cultivates 300 lbs. of product in 100 lb bulk packaging sold to Supplier B (who buys 100 lbs) and Supplier C (who buys 200 lbs). Grower authorizes (or mints) 100 lb and 200 lb NFTs, each having an authenticated chain of title back to the Grower's crop yield (also documented/linked to state, local and/or federal (when legalized) records and to Strain owner/developer. The supplier's then, for example, re-package into retail packages and themselves issue (mint) NFTs for each package up to their corresponding purchases, again tracing and authenticating the entire chain of title. An indication of the NFT may then be put on each of the retail packages authenticating it for the consumer who then also has access to the NFT and any documentation associated with the NFT and the product purchased. This provides secure authentication because each step on the way to the consumer (and there may be many) can only issue NFTs to the extent/quantities they have purchased and to a maximum extent to what has been documented as having been grown. While it may be possible to mislabel a product, it is not possible to flood the market with fake Mendocino Red Bale because the Strainable Platform prevents the creation of NFTs beyond that what was documented as being grown and only issues NFTs to verified/authenticated customers. Accordingly, any fake product would also have fake NFTs which would be easily identified through inquiry with the platform.

Nonetheless, it is anticipated that fake products will be presented in the marketplace, accordingly the present invention includes embodiments where a cannabis product is packaged with a tag or other NFT indicia that is either entirely fake (not an NFT at all) or an NFT not represented or authorized by a licensed strain, or an NFT providing incorrect or merely marketing hype as to the product. Further a mobile app that works in conjunction with the platform may be utilized to scan tags on the spot or look up product information based on any available information such as product name, grower, plant characteristics, where it was last sold, etc. In one embodiment, given incomplete information, the platform makes an educated guess as to the products authenticity and provides a risk meter from that provides a probability that the product is authenticated/documented.

In one embodiment, at the retail level for example, a checkout counter includes a register that scans the sold product automatically authenticating it and linking it to the consumer's account. The platform may maintain a record of the user's purchases such that all products may be compared and contrasted at the consumer's leisure and such information can be helpful in evaluating new products by comparing technical, environmental, and genealogic information regarding products being considered and past products which the consumer/user has personal experience. The log may include, for example, high resolution pictures and the user's own notes about product quality, taste, etc. With appropriate permission, the user's data can be utilized to better rate and describe future products that are similar to past consumer products for which the consumer has made notes or re-purchased. Such information may then be applied to similar new crops and guide a more accurate NFT creation at the Strain level for next year's crops or potentially adding an amendment to an existing NFT.

In one embodiment, the checkout counter has a counter that is a display screen laid flat in counter fashion. When the product is scanned for purchase, the counter lights up displaying summary information and high resolution pictures of the product (can be the very item being purchased, can be other products from the same license, bale, pics of the product growing). In one embodiment, some products are slated for high end markets and may include, for example, a camera placed on a particular plant that documents the plant's entire growing season and the images are morphed such that they provide a time lapse of the plant growing, the buds blooming, and then harvested—so that the consumer, via the platform, has access to the cannabis just purchased, a record of its entire life cycle.

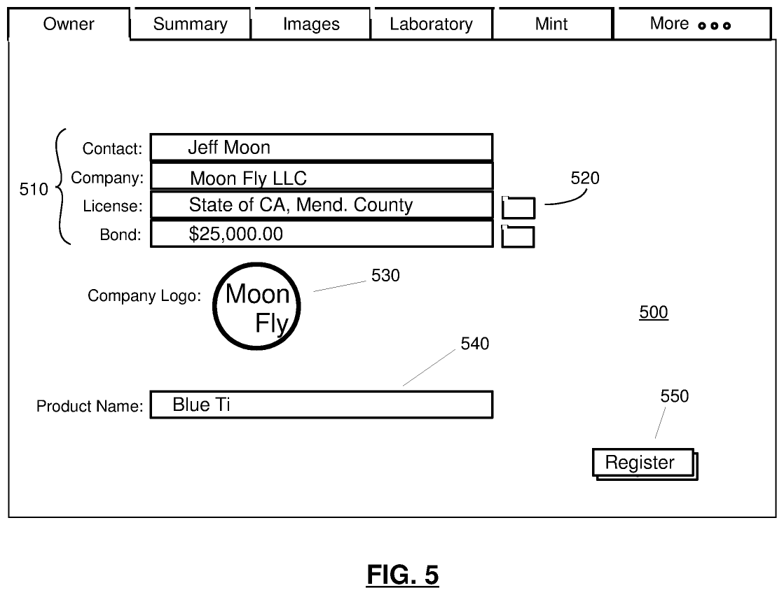

In one embodiment, there is provided a Strainable Platform configured for growers or DNA holders (e.g., rights holders). FIG. 5 provides an application/submission page 500 that may be served by the platform for registering an owner. Contact information and other details 510, for example are collected. In one embodiment, file buttons 520 are provided to upload documents supporting licenses and bonds, for example. The platform may include, for example, a standardized submission process. The submission process may include, for example verification of the grower which would include any of email verification, phone number, and/or passport scan, and confirmation of the growers address. In one embodiment, the verification requirements change depending on the level or amount of product the grower intends or typically cultivates. For example, email address verification may be sufficient for low-level “home-brew” growers. The requirements may increase at predetermined levels (weight) or dollar value. For example up to $20,000 in sales, email and credit card verification, up to $200,000 full verification. Verification may include provision of state (or Federal when applicable) licensing, business licenses, credit rating etc. Assurances on payment and refunds under certain conditions may be required or provided in some cases, and may be provided, for example, with credit card pre-authorization, deposit, purchase of a bond or insurance policy, etc. Business reputation once established may also be sufficient and is part of what is protected by using the platform, accordingly, it is advantageous for an established grower to engage with the platform so that all sales may be authenticated and documented throughout the supply chain, thus increasing the value of a specific crop or strain along raising value of all sales because of reputation protection this security provides. The registration page itself and requirements to register may differ based on a user's category, such as here, a grower, some information may be more or less important for a wholesaler or a retailer and the examples provided here are only intended to provide a number of alternatives any combination of which (along with other alternatives) may be utilized to capture identifying information, payment details, etc. In one embodiment, a similar page is utilized to registering a product, and information such as the owner's name, company logo, etc. are pre-populated or shown in summary format (rather than inputs), but the product name (e.g., 540) and any other details are provided.

Information provided to the platform will vary on a case-by-case basis, but typically include, for example:

Identifying information: For example, Name (e.g., contact name), Company Name, Logo (e.g., Logo 530, which may then be propagated to other screens describing company products, for example), Company Structure (e.g., corporation, LLC, sole proprietorship, individual, for example), License Type(s), License Number(s), and may select, for example, a package of services to be provided by and accessible through the platform.

Cultivation Methods:

Such methods, including whether grown indoors (e.g., enclosed or greenhouse), climate, lighting, etc. or outdoors including geographic information provided which is then utilized to retrieve known weather data for the location. Geographic coordinates of a greenhouse or meets and bounds of farmland may be included.
Indoor Plants—Full nutrient, microbial, light and gas regiment and any other controls like temperature and humidity.
Outdoor Plants—Geographic coordinates of grow site from which to obtain weather data, full nutrient (e.g., soil analysis), and microbial regime.

Pest Control Methods:

Full documentation of pest control, insecticides, organic and predators utilized. Documentation may include, for example, sales receipts.

Other Sustainable Farm Methods:

Use of sustainable practices should be full documented and uploaded to the platform.

COAs:

All accessible COAs from a strain, and prior COA's all lab tests.

Descriptions:

In addition to general information, the description should include all unique characteristics of a strain.

Plant Characteristics:

Such characteristics may include, for example, color, appellation, geographic location, and climate description.

Ownership Claim/Proofs:

Any documentation as to products, and may include, for example, amount of fertilizer purchased in the last year, itself is an indication of crop quantity (and may be cross checked against other records. Other records may include historical information of plant yields based on amount of fertilizer or a combination of amount of fertilizer and rainfall or irrigation (e.g. water bills or kilowatts of electricity). A formula taking those into account along with others such as climate and soil composition can be utilized to provide accurate predictions as to crop yield which may be automatically cross-referenced against data input by the grower. Any discrepancies over a certain amount or percentage may be flagged and/or asked for explanatory information (e.g., a pop-up message stating: “Crop yields indicated for the acreage exceed automated estimates by nearly 50%, please double check your yields or provide further explanatory details below.”) fertilizer

Ownership of DNA:

Name of strain. Relation to other strains (may include some type of genealogical tree). Explanation on how the strain was obtained. Earliest evidence of strain cultivation. Other information may include reference to any patent applications, trademarks or other Intellectual Property whether directly to the plant itself or technologies utilized in cultivation, harvesting, or downstream processing/packaging/storage/shipment.

Samples:

Various samples may be provided, including samples for an objective lab test, a sample for a genome or DNA test, a sample for photography, and a sample for cryo-preservation, for example.

The platform may include a number of sections, pages, or tabs. FIG. 5 provided an exemplary user identification/registration. The information may be investigated at a level appropriate to the size and value of transactions anticipated by the registration. For large growers, verification may include accessing records as to purchases or fertilizer or other supplies consistent with a crop being registered. In one embodiment, an investigator may log acreages grown by person inspection. In one embodiment, all such verifications are performed electronically such as aerial survey via airplane, drone, or satellite images and all such images may be included or linked to any corresponding NFTs. In one embodiment, registration information is checked entirely via automated resources such as accessing county business records to verify a business license, or checking registration information against other publically accessible databases. The registration process may include a permission acknowledgement granting the platform authorization to access public and private records for verification purposes.

In one embodiment, a growers indication of crops available as a basis for minting NFTs is verified through all available electronic methodologies, such as the aforementioned review of utilities (mainly water, gas, and electricity), records of land ownership or leases, known soil compositions of the lands, satellite imagery of the lands, purchase records of genetics, seeds, fertilizers, and other items. A database can be maintained that cross references yield from a plurality of similar farms with the same or similar conditions, +/− adjustments in some cases, such as −15% for inferior soil, +10% for above average rainfall, etc. Such database can then be used to make projections that, if not verify, help show red flags as to a growers claims to product quantity that may warrant physical inspection. The above may also be part of a dossier for a physical inspection.

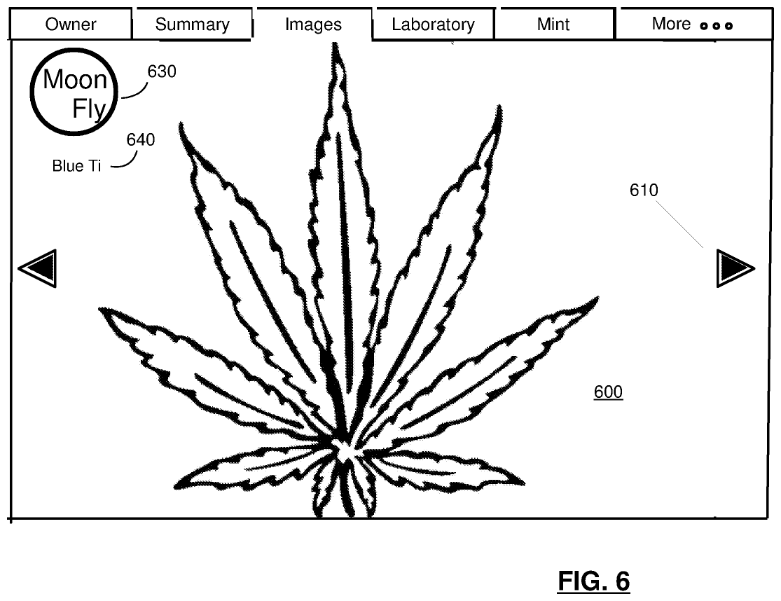

FIG. 6 is a screen shot of an exemplary images tab utilized to upload and display images (e.g., image 610) of product(s) according to an embodiment. Clicking a forward arrow 620 scrolls through the images which may also be shown in icon format, and scrolling to the end will, for example, bring up a file/upload button for additional images. Company logo 630 and product name 640 and/or other information may be provided to identify the image and strain, grower, etc.

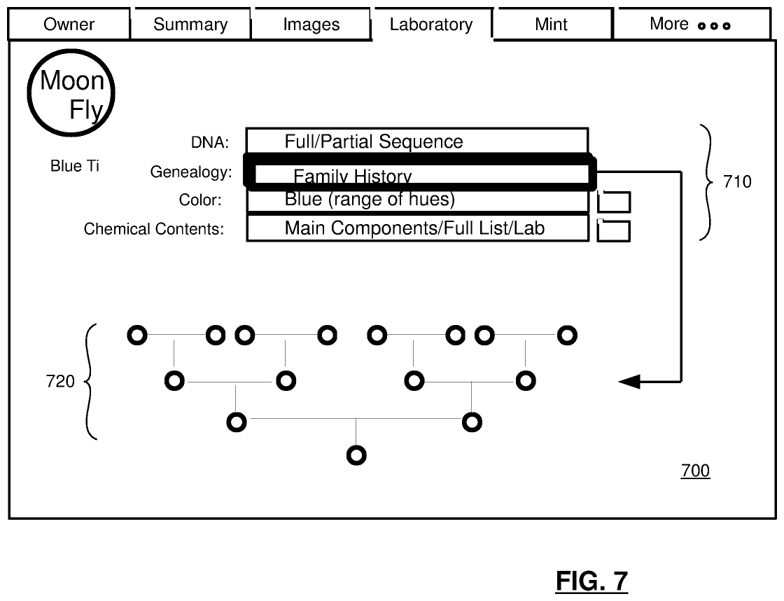

FIG. 7 is a screen shot of an exemplary laboratory input 700 including scientific inputs 710 regarding a strain according to an embodiment. The inputs may include, for example, any information regarding the content of the plant, its history, genealogy, DNA, physical characteristics, etc. Additional information may be displayed, for example, selecting genealogy may bring up a tree 720 showing popular, proven, or award winning plants in the current product's line. Clicking other fields may similarly bring up other graphics or information related to the highlighted field.

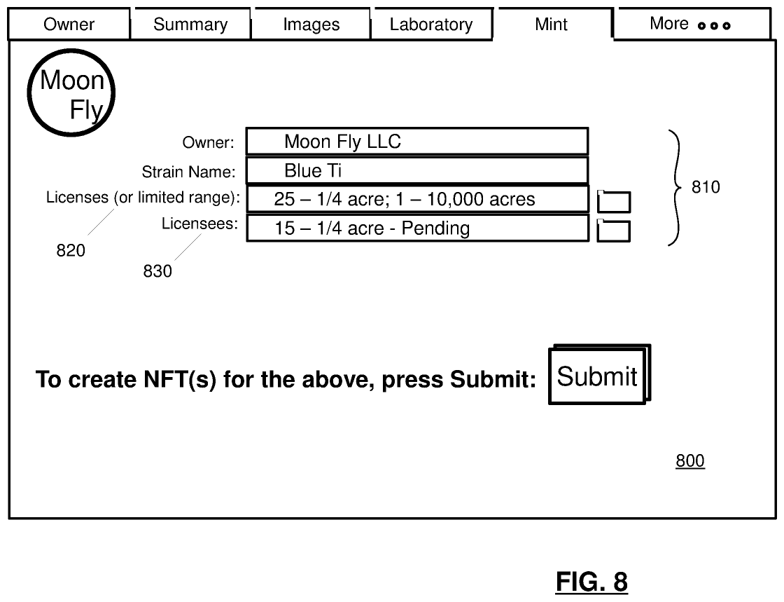

FIG. 8 is a screen shot of an exemplary mint screen 800 where a user inputs information 810 about NFTs to be created for a strain, crop, or supply according to an embodiment. The information may include, for example, licenses 820 for which NFTs are to be minted along with other NFTs (e.g., 830) already minted for this particular crop, if any. Similar information may be provided on a summary or other pages to show the current availability and/or proliferation of a particular strain. Documentation supporting the licensee(s) or potential license(s) may be uploaded using the file buttons, for example.

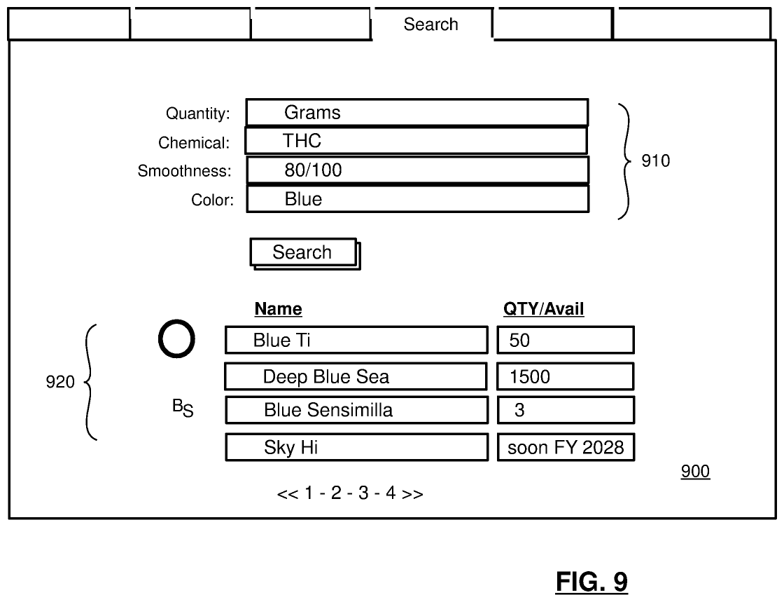

FIG. 9 is a screen shot of an exemplary search page 900 used by a user to, for example, review various available strains or products. By inputting basic information in search criteria (e.g., 910), and an exemplary results list 920 according to an embodiment is obtained. Logos, in icon form for example, may be placed next to corresponding search results for faster identification.

Other tabs may include a “start minting” page which may, for example, include a step by step list or guided (e.g., select “show me how”) tutorial to including things like, for example, step 1. Upload Genetics, 2. Upload Pictures. 3. Enter/Upload verifications/registrations, etc., 4. Select NFT particulars, and 5. Mint. Other orders or different instructions may also get the user satisfactorily comfortable with the process and the appropriate information provided/uploaded to create the NFT.

Further, a series of packages may be provided for cultivators, for example:

Level 1—BASIC—Genome Sequencing, and NFT issuance;

Level 2—Ownership Focused—e.g., includes patenting;

Level 3—Asset Focused—Listing (e.g., listing products for sale, which may include customization options);

Level 4—Marketing Focused—Consumer Market Testing, Research, Analysis and Development (e.g., may include data analysis driven by data collected by the platform in similar sales/ownership situations).

Another tab/page may include “Hot Now” which directs users to strains, products, or equipment for example that is currently getting a lot of traffic or released by prominent players in the industry, industry flash news, etc. The traffic barometer may be most viewed strains all-time and/or most viewed strain this year, last week, today, etc.

Another tab may include “Minty” configured to highlight the newest releases. Yet another tab may be a “Limited Edition” that would highlight, for example, celebrity genetics, for example, strains favored by certain celebrities or strains cultivated by celebrities. The Limited Edition tab may, for example highlight certain hard to get strains or strains developed at extraordinary expense or effort, and may be, for example, research strains being developed to push one or more chemical markers or content in the plant. The tab may further highlight commemorative blends for events and may be release at a specific event (e.g. Woodstock re-union, Sturgis 2028, Coachella, Class of . . . (select any year), etc.). Accordingly, in one embodiment a marketing plan includes a release or limited release of a product in conjunction with an event with which a memory of an event participant is fused and for which re-orders of the product are likely. In one embodiment, a re-order is accompanied with a digital copy of music or video from the event, and may, for example, be part of the platform accessible via the NFT (linked to the NFT). In one embodiment, a package including NFTs directly related to one or more recordings, videos, artwork, or other items of interest are linked to an NFT representing a cannabis purchase.

Yet another tab may be reserved for best sellers, such as all-time best selling strains or what is best selling this week (e.g., a Rogan-Musk blend that could have or may have sold briskly in the weeks after Elon's episode on Joe Rogan).

The search tab may be configured in a number of different ways. For example, it may contain the search criteria such as Strain Name, Producer Name, Yield, Potency, THC, CBD, Terpenes, Cultivation Methodology—Indoor, Outdoor or Mixed Light (any specifics of lighting such as percentages of the various wavelengths and hours of application), Sustainable Farm Methods, Earliest Evidence of Strain Cultivation, all of which may be one or more of a fill in the blank, drop down menus, radio button selection, etc.

Retail

In one embodiment, all genetics listed on the platform can be accessed via a QR code or other indicia. In one embodiment, the QR code is placed on a tag for physical reference to the genetics of the corresponding strain and may (but not necessarily) also reference an NFT minted for one or more packages/products prepared using the strain or an NFT minted for a specific package (e.g., included in the aforementioned tag which may be scanned at a retail establishment, smart phone, or home computer, for example). Such code may be electronically provided to all owners, a unique code, and such code may be placed in display cases along with their buds and/or printed on products where the strain is used (e.g., CBD from Strain A).

Because the economics of being a retailer, looking for the lowest price on products is important (e.g., retailers generally buy from the cheaper producers). In many cases, producers cut corners and use cheaper practices, quality reduces. The NFTs provided herein and associated platform/authentication are helpful for the consumer to see more clearly the quality level of a product prior to purchase.

Customers

The cannabis customer is typically looking for confidence in what they are buying, preferring a consistent product, or relevant/accurate information when looking for the occasional special use situation. This becomes more important as the user develops his/her overall sense of taste and appreciation for the plant and its various uses as a connoisseur. Unfortunately, standards within the industry are lacking or wholly deficient and without consistency. Generally speaking available products are branded, upon which the consumer relies, and quality cannot be effectively evaluated, therefore becoming a secondary concern on purchase. Consistency is difficult to come by and few brands are actually trusted, and there is a lack of ability to effectively trace the origin of the cannabis itself. Along with the great benefits to strain owners and all the way down the distribution channels, the consumer's issues are issues are also addressed by the platform by providing an easy way to verify the origin of a product, authenticate the product, its chain of title, its chain of custody, and all the available metrics as to its content, potency, taste, etc.

In one embodiment, the platform includes the ability to purchase products that meet the consumer's desired criteria for quality, content, and cost. Further, in one embodiment, the platform provides an opportunity for the consumer to invest into the strains and the producers they believe in. In one embodiment, the platform includes intelligent analysis of a consumers stated preferences and historical interaction to guide the consumer to product they might like. That same intelligence over a larger number of consumers may be utilized and applied to the various owners and growers to let them know what works and what needs to be improved. That same intelligence can be utilized to make investment choices in owners/growers, and investments by owners/growers in new equipment, research, in both for growing and strain development.

The format of the NFT or information accessed through the NFT may vary but will generally access all of the information provided and is made available to customers for review and subsequent purchase or to initiate negotiations on purchases of an entire crop, lot, or portion thereof. Purchases may include, for example, options on future crops/products. For example, sale of an option to buy a certain number of acres of next year's crop of a particular strain. Such an option (or sale of the current year's crop whether in ground or already harvested) may be identified not only by the strain but may also be allocated to a particular set of acres on a particular farm. For example, an informed buyer may realize that a particular farm has a certain set of acres that are particularly good slope for irrigation or sunshine or a particular soil composition well suited for a particular strain. Such option, and the product's corresponding NFT may identify and authenticate all the known features of the strain and its growing conditions/location, but the astute buyer may have other information or knowledge and may use that by specifying intent to buy all crop on, for example, the south slope of a farm. The NFT may further provide references to sales information, brochures, we links, etc. used to promote the product prior to sale.

In one embodiment, the platform maintains strict control over the format and order of information regarding NFTs and products displayed by the platform. The platform itself may monitor usage of the various facilities and information and change order based on human factors engineering to provide a most useful format and order of information for most of the users.

In another embodiment an input is provided from an NFT applicant or owner comprising preferences and redirect instructions for finding formatting and background information for the NFT, products of the NFT, etc. Each NFT owner will have particular reasons to highlight or put some information or a display arrangement in a specific order. Accordingly, in one embodiment a display for cannabis information authenticated by and NFT (e.g., blockchain maintained NFT) wherein preferential locations and display order of NFT authenticated items according to a remote data store or warehouse and then displayed as such with the NFT information served to a computer screen. The order and form with which the data is displayed is important to the owner because the NFT data can be voluminous and information more relevant to a sale or exchange of a truckload of 100 lb bales of cannabis will invariably be different from the connoisseur looking to find specially bred specific characteristic products, or even from a specific part of the plant. The information may change or be supplemented by multiple other downstream owners of newly generated NFTs, for example in the case of large quantities being sold and then divided into smaller batches, each batch being issued its own NFT and each batch although being of the same genetics having its own characteristics, e.g., more buds or more leaves.

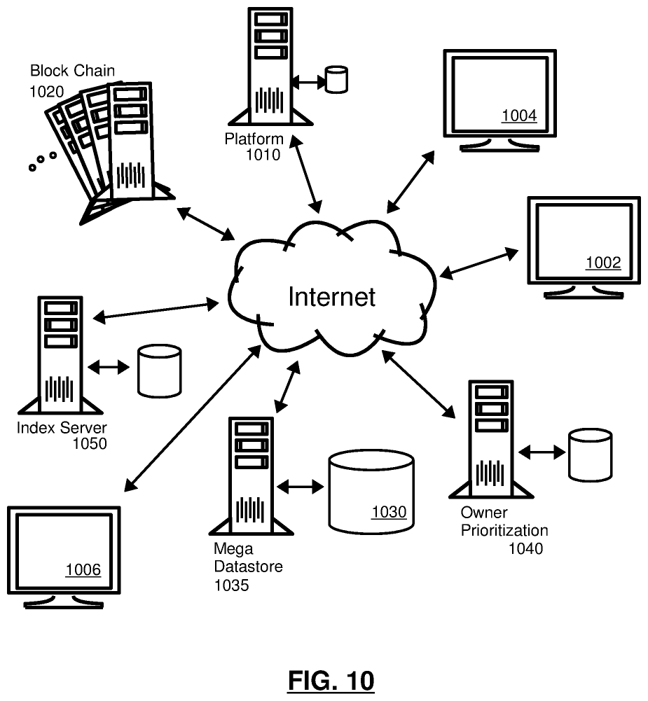

As shown in FIG. 10, these portions of the system (and platform) may be implemented, for example, as an NFT based e-commerce and/or exchange platform 1010 that includes sub-system configured to receive an indication of a cannabis NFT stored on blockchain (e.g. blockchain servers 1020) comprising data with respect to multiple aspects of a specific cannabis product, and further configured to receive and display at least part of the NFT data, a data store 1030 including a preferred selection and arrangement of ordered data derived from or associated with an authenticated NFT, a computer processor 1035 coupled to the data store and in communication through the Internet with the platform 1010 and programmed, upon receiving an indication of the NFT from the platform reaches into the data store to retrieve the preferential layout which may include for example, a composite page of the selected information which is limited with respect to the full data maintained/accessed/linked by the NFT, a selection that the NFT has been activated or otherwise accessed by a user (e.g., user 1002, or owner user 1004) via the platform and in communication with the page being displayed, and to serve the NFT's linked data (or authentication of an NFT) to the display according to remotely stored priorities and to further serve voluminous information from yet another remote computer/datastore to the display of the requesting user with the remotely retrieved prioritization formatting the page as described thereby and with content based on the NFT as directed/accessed from the additional remote source. Accordingly, the prioritized by NFT owner description or preferential order of the data associated with the product as linked through the NFT is correlated and provided. A computer processor coupled to the data store and in communication with the platform and it's user display programmed to provide owner prioritized NFT authenticated data display upon request/activation by the user to bring the prioritized information (which may be stored as prioritized, or prioritization may be accessed from a prioritization server 1040 which may provide a stored template to be applied to the data or display format) for display to the user and make available additional selective procedures such as acquiring products or making adjustments, all along with content based on the cannabis product associated with the NFT (blockchain stored NFT).

NFT Display Design

Because the NFT information may vary from one owning entity to another and because the NFT information may be voluminous (as examples), it is further also desirable to have a flexible display design where various customers, owners, or interested individuals may review the NFT information. In one embodiment, this is not a retail or sales outlet but a product information repository and authentication system which does not provide or select content (because all substantive content is part of the NFT) but provides flexibility on portions of that information displayed according to the current ownership of the NFT. The platform (e.g., 1010) may provide an interface where the NFT is identified by, for example, provision of a code or scanning a label or authorization email from the current ownership, or when logged into an app (e.g., smartphone app) linked to one or more NFTs (e.g., NFC to a reader or kiosk—kiosk 1006, for example). A secondary mechanism which may be a database, server, or other device provides construction of the display of the NFT (Data associate with the NFT), which will be obtained from either a data store (e.g., 1030/1035) either directly as identified by the NFT (e.g., retrieving a copy of the NFT from blockchain (1020) and extracting an address from the NFT or locating it elsewhere).

Alternatively an ownership or other unique indicia of the NFT is retrieved and used as an index into a data store re-direction server (e.g., index server 1050) which provides the address to the platform of the owners display priorities (e.g., as stored in prioritization server 1040) and retrieves a list of items and preferences as to order therefrom (which may be applied directly on the platform formulating a display). In another alternative the data store re-direction/index server 1050 itself retrieves the information and provides it back to the platform. The platform then takes the data and serves a page to the initial inquirer.

This architecture improves the performance and maintainability of the platform. The customization information is maintained off-platform and indexed in a manner that allows for better off-site access and update. Further, in the embodiments using an index server, although the index server may be incorporated into the platform, the index may be updated-off platform via a user interface that retrieves and verifies an owner-user and retrieves via authentication including retrieving NFT data from the blockchain and verifying it with the user-owner's information. Such index server may provide, for example, a link or address to where the information priorities can be found, thus the platform would look to the same index server for each query but could potentially return a different address/link with each query depending on a frequency of update by the owner-user. This also improves performance because the information served may be located on the most affordable computer systems having the best performance for the cost that an owner-user is willing to spend.

Even more importantly, the architecture improves flexibility and off-loads work from the platform which will be fielding work registering new owner's and collecting all data (which may include many pictures, large high-definition video files such as videos of and/or advertisements of products, security camera feeds, including live feeds during growing season and archived feeds after harvest, videos of processing and storage, of growing fields, DNA sequence listings, and other high volume data), which are substantially voluminous. Nonetheless, in some embodiments the data will be significantly less and what and how much data is ultimately tied to the NFT may be part of a package selected by the owner at registration and NFT creation. In one embodiments, the NFT carries or is associated with links to non NFT websites or data stores that maintain the high volume data feeds such as videos which may be authenticated separately through an encryption key stored with the address/link in/on the NFT in the blockchain.

Accordingly, in one embodiment a method for serving existing NFT data on a display or pages containing dynamically selected content, comprising receiving an indicia of an NFT representing a cannabis product, retrieving an address of a prioritization file, retrieving priorities from the file and dynamically constructing a display based on the priorities, retrieving data related to the NFT and allocating the data according to the priorities in the dynamically created display, populating the display based on the retrieved data and priorities, and serving the constructed page to the visitor computer via a communication link, and providing facilities for at least one of minting new cannabis NFTs related to or derived from the existing NFT data, modifying data associated or displayed for the existing NFT, selling or licensing rights to the existing NFT, documenting a purchase of products related to the existing NFT, or any of the other actions described herein related to the existing NFT.

In one embodiment, a standard Cannabis NFT format is provided, and upon serving a customized NFT layout as described above, an inquiring user may, for example, be provided a format button in which the owners display is reverted to standard form which may be helpful in some cases. In one embodiment, a process for providing an NFT format and information display format agreed upon by members of the industry, wherein patents and other intellectual property related thereto are pooled and licensed to members of a pool providing industry standard access, authentication, and information about cannabis strains, production, distribution, retail, and consumer purchase data.

In one embodiment, the platform maintains statistics on the most reviewed information and formats the standard page to place the NFT information is a format that prioritizes the most reviewed information (e.g., listing it first) or providing a summary page with what is probably all the information a majority of users will be interested in reviewing, based on historical use. Such prioritization may be applied to all cannabis NFTs or separate prioritization may be performed for each of the various types of strains or for individual customers (based on the customer's history). For example, one cannabis buyer may only be consistent interested in cost and THC content, while another is looking more aesthetics such as color and texture of the product. In each case, the most important information will be displayed first, for example, or in the summary page.

In one embodiment, a separate file with customer oriented preferences is maintained in a separate file and is served in similar fashion as the owner priorities. Allowing a customer to set priorities for viewing the NFT data may be an option on information collected from the owner upon creation of the NFT.

In one embodiment as exhibited by FIG. 10, the provision and maintenance of the platform are distributed among several computer systems 1010, 1020, 1040, 1050, for example. The data store may be implemented through a database system 1030/1035. The Internet serves as the communication link between the systems and visitor computers (e.g., user, owner user, kiosk, etc.). Accordingly, the system utilizes multiple computer systems at every level of the architecture (user level, platform level, data level, etc.). Routing between levels will distribute the load, and particularly the voluminous digital video and image requirements amongst the functioning computers and particularly to computers whose capabilities match the needs for serving/communicating or processing its corresponding data. Increasing throughput may be performed by adding more computers at the level needed and is envisioned being most needed at the data store level as more and more large capacity storage is needed and desired to be accessed by consumers, purchasers, and owners. In one embodiment, a grower links to the platform to perform functions associated with the farm, such as checking in on plant growth, pest management, or security issues. Accordingly, computers dedicated to certain types of data storage and access may be added as needed. This arrangement also provides fault tolerance since the failure of one server and its function may be re-routed to other computers not necessarily fully utilized. This approach also adds robustness by permitting the distribution of servers geographically.

Further due to security the architecture provides additional non-public security for sensitive information such as DNS sequences, genomics, and sensitive data. In addition to being voluminous, such data is securely maintained having the highest available protection and encryption and may, for example, be separated from the NFT but still referenced by the NFT or an index/indicia held by the NFT. Accordingly, the entire system provides multiple points of inventive concept that may be applied individually or together when the system is implemented. In one embodiment, both highly voluminous encrypted data is referenced by the NFT and prioritization information both of which are maintained in expandable cloud connected servers.

FIG. 11 is diagram illustrating an architecture and operational flows according to an embodiment. A platform 1110 (e.g., Strainable Platform) is in contact with a Strain Owner or developer 1115. The Strain owner may be, for example, registering with the platform, providing strain data, making an offer to sell, minting (or updating minted) NFTs related to the strain. In one flow, a strain owner mints a series of NFTs representing a license to use a strain the owner has entered, The license may be, for example, for a certain quantity of product measured in pounds, or acreage grown etc. Pricing data for the strain may vary depending on the license, for example a license to greenhouse grow under optimal conditions may be proceed for less than an open field license or vice versa. Selection or sale of any one license may change the terms or render other licenses unavailable (as would be the case when a buyer exercises an option for exclusive use of the strain).

NFTs may be minted in a process similar to as discussed above, and the data for the NFT included or coded into the NFT or stored elsewhere and referenced or indexed by the NFT. The minted NFTs may be stored, for example, in blockchain 1120. In one embodiment, basic information about the NFT is publically accessible and further confidential information about the strain is associated to the NFT either as referenced by the NFT or indexed by the NFT (and providing extra security). This, for example, for storage of genetic information, or other sensitive data which also may be voluminous and may not be ideal for blockchain storage and in need of additional security such as encryption, limited access, etc. In one embodiment, data is referenced or indexed according to an NFT or indicia associated with the NFT. For example, a separate server that receives an NFT and identifies an index and an encryption key to retrieve sensitive data. In one embodiment, a corresponding key is provided to the owner at the time of NFT creation and such key may fully secure data that needs to be secure and make in inaccessible without both keys. The server may access the platform to further assure that the transaction is authorized (e.g., confirm request is coming from an authorized user—such that a request to confirm that a request that is believed to be coming from the platform is sent back to the platform for confirmation—in one embodiment such confirmation is requested and sent through a different communications channel (e.g., text message) than what the original request was received.

Although the various embodiments have been described herein mainly with reference to cannabis and cannabinoid products, and their related specifics, qualities, etc., the devices and processes of the embodiments may be applied to other agricultural or farm products, or any other products and their corresponding specifics or qualities including mechanical or other systems that may be appropriately described by materials, material composition or molecular structure.

A Licensee or Grower 1130 may access the platform 1110 to search for and purchase strain rights. After purchase of the rights any transfer of product such as seeds or genetic materials, plants, etc. may be shipped directly from the strain owner to the grower 1117. The grower may identify an amount of product associated with the NFT (amount of cannabis grown) and may divide the crop in any suitable manner by pounds, by growing location, or any other dividing factor that makes sense for the product or as desired by the grower. The grower may then access the platform and create NFTs for each proportion of the crop. The NFTs, along with any associated information provided by the grower (or strain owner) may then be placed on the platform for sale to, for example, a wholesaler or distributor. The NFT may be held privately by the platform or made accessible to other platforms based on policy of the platform. In one embodiment, the blockchain NFTs and all other data is privately held by the platform without public access. In another embodiment, the blockchain NFTs are publically accessible and may be used by other platforms. In one embodiment, the platform places NFTs and summary and public information available to the general public and information identified as confidential in a private database or blockchain accessible via the public NFT on blockchain.

A wholesaler 1135 accesses the platform 1110 to review available cannabis for sale. Selections and purchases can be made from the platform which may also assist with transfer of assets payment, and the product may delivered from the grower, for example, grower 1130 via transfer 1132. As with the wholesaler, the grower may mint additional NFTs for portions of that purchase or may utilize NFTs passed along (purchased from) from the grower 1130, such as in the case where the entire lot is sold by the wholesaler, additional NFTs may not be necessary but could still be utilized. A distributor may be involved to purchases from the wholesaler and then mint additional NFTs according to how the wholesale purchase is divided up and perhaps repackaged. The package products (or even still unpackaged larger quantities) may be placed on the platform 1110 for sale or advertised by other means such as Internet advertising.

In the normal course of operation, a retail establishment 1140 will purchase one or more of the packaged goods or bulk products and may themselves repackage them into retail packages if needed or desirable (e.g., if not already done by the wholesaler or distributor). The wholesalers purchased from the grower may be transferred her an after payment on via physical transfer 1132 and the product to the retailer may be transferred from a wholesaler or distributor during a transfer 1137.

Either the wholesaler or the retailer, for example, may access the platform and request that tags or a QR code or other seal of authenticity be provided. In one embodiment, the platform authorizes the creation of the tags and automatically sends the request to an outside organization access through the cloud and such tags would then be delivered to the wholesaler or retailer 1145. Tag creation being outsourced provides the advantages of always having equipment available to prepare tags with the latest technology and having a modern tag adds to the authenticity that the underlying or linked NFT represents. In one embodiment, the tag is printed on-site, such as in a prescription filling work area of a dispensary and the platform may, for example, communicate tags in electronic format to the dispensary. In one embodiment, a dispensary or retail outlet takes the last step in the ownership chain by purchasing bulk quantities of cannabis, packaging the cannabis in retail quantity packages, creates NFTs (e.g., on the platform), prints-out tags linked to the NFTs and attaches then to the packages which are then distributed to a user upon purchase, set in a display case, etc. In one embodiment, a workstation is prepared that automates the steps such that a retail outlet worker informs the platform that a previously purchased quantity of cannabis product that has been purchased is being divided into retail packages of a predetermined amount by minting NFTs for each package (e.g., a 5-pound purchase of Blue Ti being divided into 80-1 oz. packages). Ultimately, a consumer purchases a retail product such as package 1160. The package includes a tag/QR code/seal of authenticity 1165.

The tag 1165 may be scanned at various points by the retailer or wholesaler/distributor depending on the route the product takes, and/or by the consumer, for example, at a kiosk 1155 using, for example, a scanner 1170. Upon scanning, the platform may be accessed via the cloud (or other means) to run an Authentication on the scanned tag. The result is then displayed on the kiosk (a similar process may be initiated at a cash register scan of the product, and, in one embodiment, the tag not only is used by the platform for authentication but also provides pricing information to the retail establishments check out system. The result shows, for example, that the product is authenticated (or not authenticated) and may provide some basic information about the product such as the product name (e.g., Blue Ti), how it was authenticated (e.g., blockchain, Strainable), a logo (e.g., Moon Fly) associated with the product and the kiosk may also display a button such that the consumer may enter the platform to review further details about the product. Any such details authorized throughout the chain in which the consumer is allowed to access may be accessed via one or more menus or tabs or other formats such as those described above.

In one embodiment, the platform is linked to the accounting/bookkeeping of one or more of the entities using the platform (e.g., strain owner, wholesaler, retailer, or user). The sales are made on via the platform may be tracked by the platform as well as purchases, NFT creation, and may provide charts graphs and spreadsheets. In one embodiment, the platform accesses an API to report all sales and purchases to an accounting application used by the entity (e.g., Quickbooks). In one embodiment, the platform prepares data in a format and/or enters data into an API for tax preparation purposes or may be a direct link/communication to tax preparation software (e.g., TurboTax), on-line tax preparation (e.g., H&R Block on line, Liberty, etc.) or other services. In one embodiment, the accounting and tax aspects are maintained on the platform and formatted for platform-centric reporting or used in other information to be communicated to the entity (e.g., such as news or advertising relevant to the purchases/sales). In one embodiment, the accounting information is reported to Quickbooks and maintained for platform centric uses.

Further, the platform may support many different types of APIs or other interfaces for providing information or data about the strains or products, such as those having minted NFTs, on the platform. For example, providing data to federal and/or state regulators for licensing or growing cannabis products. An API may be provided to a specific agency over a secured link for that agency's exclusive use, or a more generalized API may be provided in which any registered agency may utilize. Some data may also be released with full public access and users, owners, and growers, may set such privileges with respect to any or all products, strains, etc.

In one embodiment, an interface such as an API may be utilized to provide information about strains and products to one or more track-and-trace systems used by the various regulatory agencies to track commercial cannabis activity and movement across the distribution chain (“seed-to-sale”). The API may provide, for example, information such as any sales or transfers, processing (e.g., packaging or how a crop has been packaged or divided up, up to full tracking and accountability, including taxation) information across the chain as the platform itself will typically fully track all sales/distribution activity.

Further, the API can provide authentication of any of the strains or products associated or managed by the platform to the agency or its authorized contractors. For example, in one embodiment, verification of any code scanned by a regulatory agency 1118 (such as Metrc) may be packaged into a request (e.g., API invocation 1114) sent according to an API (e.g., API 1112), and to which the platform responds through the API (e.g., response 1116) which may be, for example, an authentication of any of the strain associated with the scan, its composition, owner, source, etc. In one embodiment, the API invocation 1114 has partial information, such as a name, an address, or any other information available about a product, a business, a location, or an owner and the response 1116 is a list of potential matches if any.

In one embodiment, such API requests may performed via a special purpose weed scanning app on agency personnel smart phones, or may be an option provided on an existing app or computer program on an agency device or accessed via a web portal using a generic Internet browser, and preferably all such communications here and elsewhere described herein are performed over secure links/communications. In one embodiment, a simplified response of a pass/no pass response is provided indicating that the product has a legitimate chain of title, and/or is in a location where it is supposed to be, and/or is in compliance with state and/or any federal requirements (e.g., in compliance with California's tracking and reporting requirements).

Various APIs may be provided for specific needs within the industry. For example, an API that provides information for one or more weed apps, such as cannabis dispensary locations. In one embodiment, a cannabis dispensary locator app accesses the platform through an API to determine stock levels at various dispensaries of a particular brand or type of cannabis identified in a search filter from a user of the app. In another embodiment, a cannabis delivery service app accesses the platform for updates on any locations, hours, stock information, etc. to be displayed on a map in the delivery service's home range. In one embodiment, an app utilized by a delivery service takes orders and then plots a course for the delivery-person to follow such that needed cannabis products can be picked-up at a dispensary and then delivered to the various customers in queue in the most efficient manner. In one embodiment a maps API receives a cannabis product name and returns a list of establishment names and locations and short descriptions (e.g., hours, superstore, etc.)—the type of information that can be displayed on the map along with location of establishments having that product.

In one embodiment, a preferences page includes a selection of all types of services that may want to utilize the app and the user can select all, none, or a customized list of services that will have access to a user's stock (or other) information. In one embodiment, a preferences pages include required regulatory agencies for a user's location, and such selection may be checked and unalterable by the user. A strain owner, wholesaler, and/or retailer in California would, for example, have permanent checkmarks next to Metrc and the California Department of Cannabis Control, along with optional permissions for the various weed apps.

In one embodiment, a preferences page comprises preferences including a list of weed apps with whom user data or information may be shared. Each selection may have, for example, an advanced tab where the type or specific information allowed to be shared with each app or each app type may be provided. In one embodiment, the weed apps are divided into groups, such as location apps, delivery apps, mapping apps, and permissions may be set on a group level such that all similar apps are granted the same permissions. In one embodiment, the platform pre-selects the various weed apps. In yet another embodiment, membership level on the platform provides differing levels of selectivity. For example, free or less expensive memberships on the platform automatically make all information available to the weed apps as decided by the platform, while a premium membership may provide partial or complete control of information distributions.

Archives 1125 may be configured to store most of the voluminous data regarding each NFT as indexed by or in association with the NFTs in blockchain 1120 and provide additional security at a level appropriate for the sensitivity of the data. The archive itself may be a blockchain. Along those lines, in one embodiment, an NFT-A in a blockchain representing ownership or other rights in a cannabis product that references another NFT-B in another blockchain (could be the same blockchain) comprising data related to the ownership or other rights. In one embodiment, NFT-B contains basic information about the rights and links to detailed or voluminous information stored on a secure server.

In one embodiment a NFT linked scannable code (e.g. QR code) is placed on packages placed on shelf in a brick & mortar store. The package may be a box, bottle, plastic wrap or other container, envelope, etc. The product may be entirely cannabis, plant material, product made from cannabis, or a typical consumer product, such as soda, juice, food, candy, wine, beer, whiskey or other alcoholic beverages infused with cannabis or CBD for example. A customer coming into the store with a platform linked app can scan each of the products and view an NFT blockchain authentication and complete chain of title of the product. This is useful at least in cases where the customer is looking for certain qualities in the cannabis product, such as raw cannabis or a downstream product such as hemp or CBD.

In describing the embodiments, and as illustrated in the drawings, specific terminology is employed for the sake of clarity. However, the various embodiments are not intended to be limited to the specific terminology so selected, and it should be understood that the ordinarily skilled artisan may utilize similar, related, or even different terminology depending on the embodiment or selected topic therein to discuss or describe the same. Further, it should be understood that each specific element includes all technical equivalents which operate in a similar manner, as will be understood by the artisan. For example, when describing an NFT such may be composed of various structures, and any other equivalent structure, format, or tool for implementing the same having an equivalent function or capability, whether or not listed herein, may be substituted therewith. Furthermore, the inventor recognizes that newly developed technologies not now known may also be substituted for the described parts and still not depart from the scope of the present application or any of the embodiments. All other described items, including, but not limited to blockchain, tokens, keys, or other parts of the present application should also be considered in light of any and all available equivalents.

Portions of the various embodiments may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The various embodiments, or portions thereof, may also be implemented by the preparation of application specific integrated circuits or by interconnecting an appropriate network of conventional component circuits, as will be readily apparent to those skilled in the art based on the present disclosure.

The various embodiments include a computer program product which is a storage medium (media) having instructions stored thereon/in which can be used to control, or cause, a computer to perform any of the processes of the embodiments. The storage medium can include, but is not limited to, any type of disk including floppy disks, mini disks (MD's), optical discs, DVD, HD-DVD, Blue-ray, CD-ROMS, CD or DVD RW+/−, micro-drive, and magneto-optical disks, ROMs, RAMs, EPROMs, EEPROMs, DRAMs, VRAMs, flash memory devices (including flash cards, memory sticks), magnetic or optical cards, SIM cards, MEMS, nanosystems (including molecular memory ICs), RAID devices, remote data storage/archive/warehousing, or any type of media or device suitable for storing instructions and/or data.

The various processes described herein may further be implemented in app running on a mobile device including Android, IOS or other systems. Such app may, for example provide information similar to the platform, and any or all functionality thereof. Location data may be utilized to show maps of facilities in a local vicinity of the app user, for example. The app may include services including identification of varieties or strains of various products, and such identification may be performed by image matching (e.g., using AI or probabilities, for example) and/or combined with location data which may correspond to a known growers farm, for example.

Stored on any one of the computer readable medium (media), the embodiments may include software for controlling both the hardware of the general purpose/specialized computer or microprocessor, and for enabling the computer or microprocessor to interact with a human user or other mechanism utilizing the results of any embodiment or variations/equivalents thereof. Such software may include, but is not limited to, device drivers, operating systems, and user applications. Ultimately, such computer readable media further includes software for performing any embodiment as described above and equivalents thereof.

Included in the programming (software) of the general/specialized computer or microprocessor are software modules for implementing the teachings of the various embodiments, including, but not limited to, populating block-chains, NFTs, and other data structures, searching blockchains or NFTS, linked blocks chains, retrieving blockchain/NFT stored information and providing it to registered and verified users which may include producers, wholesalers, retail, or any point in the supply chain and providing such information to web sites or other systems, The identification and storage of certification information, and the display, storage, or communication of results according to the processes as described herein and equivalent processes whether or not described herein.

The embodiments may suitably comprise, consist of, or consist essentially of, any of element (the various parts or features of the embodiments) and their equivalents as described herein. Further, the embodiments illustratively or literally disclosed herein may be practiced in the absence of any element, whether or not specifically disclosed herein. Obviously, numerous modifications and variations of each embodiment are possible in light of the above teachings. It is therefore to be understood that within the scope of any claims that may be late drawn, the invention, or any embodiment thereof, may be practiced otherwise than as specifically described herein.

The following are examples of various embodiments, including (e.g., example embodiments). Example 1 is a cannabis exchange with a plurality of strains of cannabis maintained in NFTs of a block-chain and an interface for searching and reviewing cannabis strains in the collection. The NFTs may include, for example, at least one of Strain Name, Producer, Yield, Potency, THC, CBD, Terpenes, and Cultivation Methodology with respect to each strain. The interface may be a grower specific interface with searching functions of interest to growers (e.g., b2b searches), and a consumer specific interface with searching functions related to consumer interest.

Example 2 is a method, having steps for populating an NFT of block-chain with specifics of a cannabis strain and providing portions of the NFT to third parties for evaluation of the cannabis strain. The specifics may be, for example, any combination of Strain Name, Producer, Yield, Potency, THC, CBD, Terpenes, Cultivation Methodology, and Geographic Origin. Alternatively or in addition, the specifics comprise IP information, Licensing information, and earliest evidence of strain cultivation. The specifics may be or further include any one or more of an offer to license a strain, a genetic analysis, documentation from a supplier, growing conditions of the strain, chemical content, taste, age, genetics, growing conditions, age, or other specifics of the strain. Providing may include populating a retail web page with selected specifics and/or verification of the specifics of the strain and/or providing a service including a genetics search function of the block-chain. The specifics may be DNA data of the strain and providing may be providing a service including geographic transmission of the DNA data. The method may further include linking one or more NFTs to verification by an independent standards, testing, or review organization. The NFT itself may be a tradable quantity of cannabis or bundle of rights to the cannabis or its strain.
Example 3 is a cannabis exchange, comprising a plurality of strains of cannabis maintained or identified in a collection NFTs in blockchain, and an interface for searching and reviewing cannabis strains in the collection. The NFTs may include, for example, specifics of a cannabis strain including at least one of Strain Name, Producer, Yield, Potency, THC, CBD, Terpenes, Cultivation Methodology, and Geographic Origin with respect to each strain. The interface may be or include a grower specific interface with searching functions of interest to growers (e.g., b2b searches), and a consumer specific interface with searching functions related to consumer interest. An NFT minting mechanism may be configured to mint new NFTs to the block-chain.

The example may include an NFT population mechanism configured to add specifics or information pertaining to specifics to an NFT. An information retrieval mechanism configured to retrieve information from an NFT and send it to a requester. The requestor may be a user logged into a platform or may be a web page server (e.g., secure web server). The example may include an independent security module configured to control access to the NFTs. A portion of the security module or information needed to implement security may be maintained in the NFT. A portion of the security module or information needed to implement security may be maintained in a separate blockchain. The specifics may comprise any combination of Strain Name, Producer, Yield, Potency, THC, CBD, Terpenes, Cultivation Methodology, and Geographic Origin. The specifics comprise any combination of Strain Name/Identifier, Producer, Potency, and Geographic Origin. Potency may be a measure of either THC or CBD. The specifics may further include any of IP information, Licensing information, Earliest Evidence of Strain Cultivation, licensing information, genetics analysis, growing conditions(s).

The information retrieval mechanism may be, for example, a mechanism for populating a retail web page with selected specifics and/or verification of the specifics of the strain and/or licensing information of the strain. The retail web page may provide a selection of certain specifics and information about how to display the specifics which is utilized by a 3^{rd} party computing device to prepare a web page and send it as the retail web page to a user (either via the original retail web page hosting mechanism or as a communication directly to the user. The user may be logged into the platform or have arranged for automatic login, the platform receives the generated web page and displays it in response to the user's request at a 3^{rd} party website. Wherein the page generated is according to selected specifics, display information, and platform standards, and is transmitted by the platform to a 3^{rd} party website for display in response to user action at the 3^{rd} party website.

The example may further include providing a service including geographic transmission of the DNA data. At least one of the specifics may be a link to verification by an independent standards, testing, or review organization. At least one of the specifics may be a secured fillable data module accessible for filing and/or updating only by an independent standards, testing, or review organization. At least one of the NFTs may contain at least one module populated by independent standards, testing and review organizations. The NFTs may contain a plurality of modules each filled by an (e.g. assigned) independent organization.

The example may yet further include comprising a separate verification blockchain including independent standards, testing, or review information about one of more of the strains in the NFTs. A link may be provided between at least one NFT and an independent standard, testing, or review organization. The separate verification blockchain may include verification, licensee, and sales information. The separate verification blockchain may include verification, licensee, and sales information provided to a website or other information place in conjunction with information from the NFTs. The NFTs may represent any of a tradable or divisible quantity of cannabis, a tradable divisible bundle of rights to a strain that may include certification rights, printing rights, rights to an independent certification certificate, market outlet rights, distribution channel rights, a given amount of any of airtime, click-troughs, or views on one or more platforms, rights to elevated search results, rights to social media or vlogs promotions, at least one key for unlocking other features, and tradeable advertising rights including any one or more of any of the aforementioned advertising related rights. Other features may include, for example, medallions or badges that may be unlocked (e.g., for display on an individual user's social media account or an app associated with the platform). The other features comprise medallions or badges that may be unlocked for display on an individual user's personal inventory or collection of previous purchases. The other features may be medallions or badges that may be unlocked for display on a retail outlet's web page or in-store advertising.

The NFTs may include links or programs configured to populate a vlog or an advertising channel, one or more advertising channel portals, links or programs configured to populate other NFTs in other block-chains. The rights or products maintained or linked to or via the NFTs are agricultural and not necessarily cannabis related. The rights or products maintained or linked to or via the NFTs may be non-agricultural. The bundle of rights may comprise, for example, options or rights to future quantities (e.g., options to purchase future quantities). The term “cannabis” may be swapped with another noun descriptive of the product and/or rights contained in the NFTs or a non-cannabis product. The term cannabis is swapped with any of medicine, chemicals, liquor, drugs, food, or other commodities.

In one embodiment, a website that derives content from an NFT in a blockchain, wherein the content comprises any of the information of links described in the above example or other embodiments describe herein.

In one embodiment, a method comprising providing a certification to a supplier, wholesaler, distributor, or retail outlet that comprises a distributable key, keys, or portion thereof that may be forwarded to a user or downstream acquirer of a cannabis product, or rights thereto, that unlocks a certification, badge, medallion, or other indicia of the product. Wherein the certification, badge, medallion or other indicia is in a format that may be displayed in an electronic communication. Wherein the certification, badge, medallion or other indicia is provided in, maintained in, or linked to an NFT of a block-chain.

Sales of a product (for example, including rights to a product) wherein the product includes a block-chain maintained certification as to any one or more specifics about the product. Wherein the certification is an independent certification pertaining to quality or content or the product. Wherein the certification comprises a badge or icon comprising, for example, a certificate of authenticity, origination, or quality relating to a product, event, or sample. Wherein the certification may include insurance. Wherein the certification comprises a distributable key that may be passed to one or more subsequent purchasers. Wherein the product is a cannabinoid. Wherein the product is IP rights to grow a strain of cannabis. Wherein the product is a right to clone a strain of cannabis. Wherein the product is the right to perform a method related to cannabis production. Wherein the product comprises a wholesale quantity of cannabis.

Again, numerous modifications and variations of each embodiment described herein are possible in light of the above teachings. It is therefore to be understood that within the scope of any claims that may be late drawn, the invention, or any embodiment thereof, may be practiced otherwise than as specifically described herein.

What is claimed is:

1. A platform, comprising a user interface including menu options for, receiving an identification of cannabis and an identification of rights associated with the cannabis, and minting an NFT for the identified cannabis and associated rights.

2. The platform according to claim 1, wherein the identification of cannabis comprises an identification of a strain of cannabis comprising at least one of a physical description, a genetic description, and a biological description.

3. The platform according to claim 1, wherein the identification of rights comprises at least one of a bundle of rights from an owner of the identified cannabis including at least one of license or purchase of right to grow the identified cannabis, right to cross-breed the identified cannabis, right to sell the identified cannabis, and right to license the identified cannabis.

4. The platform according to claim 1, wherein the NFT is stored in blockchain.

5. The platform according to claim 5, wherein the blockchain is encrypted and information is available based on a security level such that some of the information is publically available, semi-publically available, and private.

6. The platform according to claim 1, wherein the identification of cannabis comprises an identification of a quantity of cannabis and the NFT is an exchangeable representation of ownership of the identified quantity of cannabis.

7. The platform according to claim 1, wherein the menu options include minting multiple NFTs for the identified cannabis and associated rights.

8. The platform according to claim 7, wherein the multiple NFTs each include a portion of a bundle of rights associated with the identified cannabis.

9. The platform according to claim 7, further comprising a physical authentication tag affixable to a cannabis product and associated with an NFT minted by the platform for the cannabis product.

10. The platform according to claim 9, wherein the NFT comprises one of a plurality of NFTs minted with respect to a larger quantity of cannabis at a wholesale or distribution level divided into retail packages on each of which is affixed a tag associated with its corresponding NFT.

11. The platform according to claim 10, wherein the platform is in communication with a retail outlet for at least one of authentication of products having an NFT minted by the platform, and provision of retail sale information beyond product name and pricing.

12. A method, comprising the steps of:
receiving a quantity of cannabis;
dividing the cannabis into retail packaging;
minting NFTs corresponding to each retail package; and
attaching a QR code or other scannable code to each package;
wherein the scannable code on each package relates to the NFT created for that package.

13. The method according to claim 12 further comprising the steps of placing the minted NFTs in blockchain and retrieving the NFTs as a part of a process of authenticating a package of cannabis and displaying the authentication along with relevant information including an image of the cannabis.

14. The method according to claim 12, further comprising the steps of photographing each divided portion of cannabis and associating the photograph with the NFT affixed to the retail package for that divided portion of cannabis.

15. The method according to claim 12, further comprising the step of installing a kiosk at a retain location configured to scan products with NFT associated scannable codes, reach out to a platform to authenticate the NFT and display an indicia of authentication.

16. A method, comprising the steps of:
identifying a desirable lot of cannabis at the wholesale level;
retrieving a code associated with the desirable lot of cannabis, the code further associated with either an NFT representing the lot of cannabis and/or a platform hosting the NFT;
logging into the platform hosting the NFT and purchasing the NFT;
creating a plurality NFTs each representing one or more portions of the desirable lot of cannabis; and
offering the plurality of NFTs for sale.

17. The method according to claim 16, wherein the step of scanning provides publically available information as to the platform on which the cannabis is offered for sale.

18. The method according to claim 16, wherein the step of retrieving comprises scanning a physical tag associated with the lot, the scanning performed on a smartphone at an auction or warehouse, and transferring the scanned information to an app in communication with the platform which displays summary information and an indicia of authentication and/or chain of title of the lot.

19. The method according to claim 16, wherein the portions comprises distribution level packaging.

20. The method according to claim 16, wherein the portions comprise retail level packaging, the method further comprising the step of delivering a plurality of the packages to a purchasing retail outlet.
